(19) United States
(12) Patent Application Publication
(10) Pub. No.: US 2024/0276227 A1
(43) Pub. Date: Aug. 15, 2024

(54) METHOD AND SYSTEM FOR VALIDATING A PHYSICAL PRESENCE OF A WIRELESS COMMUNICATION DEVICE WITHIN AN ENCLOSED VOLUME

(71) Applicant: Universal Avionics Systems Corporation, Tucson, AZ (US)

(72) Inventors: David GRABLE, Tucson, AZ (US); Thor SKAUG, Tucson, AZ (US)

(73) Assignee: Universal Avionics Systems Corporation, Tucson, AZ (US)

(21) Appl. No.: 18/632,307

(22) Filed: Apr. 11, 2024

Related U.S. Application Data
(63) Continuation of application No. PCT/US2022/046247, filed on Oct. 11, 2022.
(60) Provisional application No. 63/254,170, filed on Oct. 11, 2021.

(51) Int. Cl. H04W 12/64; H04W 12/65; H04W 64/00

(52) U.S. Cl. CPC H04W 12/64; H04W 12/65; H04W 64/006

(57) ABSTRACT

A method and system for validating a physical presence of a wireless communication device within an enclosed volume, upon establishing a wireless communication channel with an access point physically located within the enclosed volume. The system may include: a wireless communication device equipped with at least one sensor which is configured to detect the wireless communication channel, wherein the sensor is configured to capture validation data from a validation device physically located within the enclosed volume, wherein the validation data is repeatedly generated; and an access point physically located within the enclosed volume and configured to establish the wireless communication channel with the wireless communication device only upon determining that the sensor correctly captured the validation data, wherein the sensor and the validation data are such that the sensor correctly captures the validation data only whenever the wireless communication device is physically located within the enclosed volume.

This application is a Continuation Application of PCT Application No. PCT/US2022/046247 filed Oct. 11, 2022, claiming priority from U.S. Provisional Patent Application No. 63/254,170 filed Oct. 11, 2021, both are incorporated herein by reference in their entirety.

### FIELD OF THE INVENTION

The present invention relates generally to the field of securing wireless networks, and more particularly to conditioning access to a wireless network upon location of the wireless communication device.

### BACKGROUND OF THE INVENTION

Prior to the background of the invention being set forth, it may be helpful to provide definitions of certain terms that will be used hereinafter.

The term “wireless communication device” as used herein is defined as electronic or electrical device capable of remote communication or devices enabling wireless connectivity. Examples include cell phones, smart phones, personal digital assistants (PDAs) and portable computers (commonly called laptop computers).

The term “wireless access points” as used herein is defined as wireless communication devices that create a central point of wireless connectivity. A wireless access point behaves much like a “hub” in that the total bandwidth is shared among all users for which the device is maintaining an active network connection.

The term “avionics” as used herein is defined as electronic systems used on aircraft. Avionic systems include communications, navigation, the display and management of multiple systems, and the hundreds of systems that are fitted to aircraft to perform individual functions. These can be as simple as a searchlight for a police helicopter or as complicated as the tactical system for an airborne early warning platform.

Adding a wireless network access point to an aircraft cockpit creates a potential risk where wireless communication device s that are not present inside the cockpit or in the aircrew's possession, may attempt to connect to the wireless network and potentially impact the safety of the avionics components and their communications.

Wireless networks are discoverable within a range of more than 150 ft and only require connecting devices to enter a static pass phrase (or similar) to authenticate the connection. Other solutions implement a secondary pairing of devices to the avionics by generating a security key on the connecting device that is then entered in the avionics to complete the pairing.

The limitations and/or drawbacks of known solutions are that the network name and/or connection details are created once and can be compromised (e.g., stolen or discovered by an adversary). Additionally, the process of connecting/pairing the device to the network and avionics is cumbersome and error prone.

Finally, solutions that rely on human entry of a secure code can be subject to spoofing attacks and therefore undesirable.

### SUMMARY OF THE INVENTION

In order to address the drawbacks of the prior art, some embodiments of the present invention verify and guarantee that a wireless communication device is in the possession of the aircrew when they try to establish a connection with the aircraft avionics over a wireless communication channel. Such a connection is only established if the wireless communication device is verified as being in the possession of an authorized aircrew person.

Some embodiments of the present invention create a new wireless network security access code for each flight, or at the request of the aircrew.

Some embodiments of the present invention simplify the pairing mechanism for the wireless network relying on the user device to scan the security access code. This guarantees that the device is in the cockpit at the time it is paired. This reduces the potential for human error and vulnerability to spoofing.

According to some embodiments of the present invention, a method, and a system for validating a physical presence of a wireless communication device within an enclosed volume, upon establishing a wireless communication channel with an access point physically located within the enclosed volume, are provided. The system may include: a wireless communication device equipped with at least one sensor independent of the wireless communication channel configured to detect the wireless communication channel, wherein the sensor is configured to capture validation data from a validation device physically located within the enclosed volume, wherein the validation data is repeatedly generated; and an access point physically located within the enclosed volume and configured to establish the wireless communication channel with the wireless communication device only upon determining that the sensor correctly captured the validation data, wherein the sensor and the validation data are such that the sensor correctly captures the validation data only whenever the wireless communication device is physically located within the enclosed volume.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram illustrating the environment of a system in accordance with embodiments of the present invention;

FIG. 2 is a block diagram illustrating an architecture of a system in accordance with embodiments of the present invention; and

FIG. 3 is a high-level flowchart illustrating a method in accordance with embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following description, various aspects of the present invention will be described. For purposes of explanation, specific configurations and details are set forth to provide a thorough understanding of the present invention. However, it will also be apparent to one skilled in the art that the present invention may be practiced without the specific details presented herein. Furthermore, well known features may be omitted or simplified in order not to obscure the present invention.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

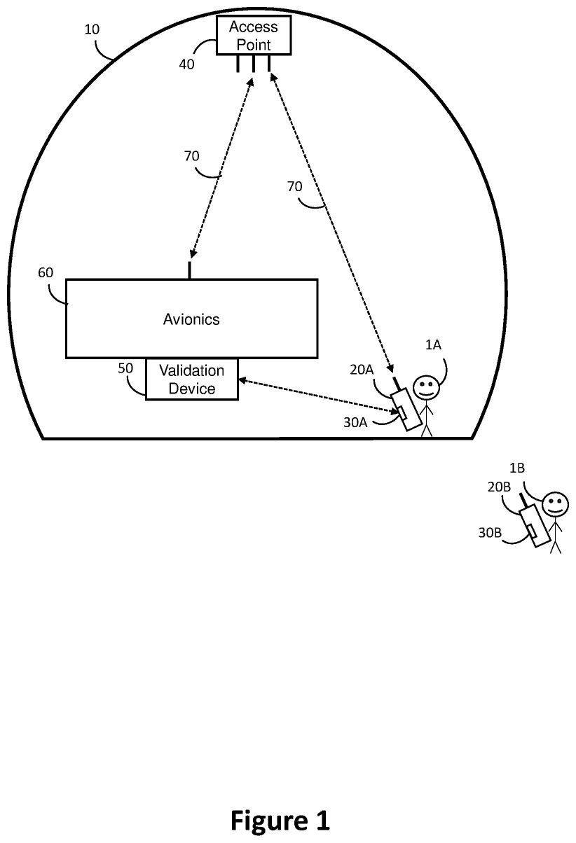

FIG. 1 is a block diagram illustrating an architecture of a system for validating a physical presence of a wireless communication device 20A associated with person 1A within an enclosed volume 10, upon establishing a wireless communication channel 70 with an access point 40 physically located within enclosed volume 10.

According to some embodiments of the present invention, the system may include a wireless communication device 20A equipped with at least one sensor 30A independent of the wireless communication channel configured to detect the wireless communication channel 70, wherein sensor 30A may be configured to capture validation data from a validation device 50 physically located within enclosed volume 10, wherein the validation data may be repeatedly generated and updated.

According to some embodiments of the present invention the system may further include an access point 40 physically located within enclosed volume 10 and configured to establish wireless communication channel 70 between wireless communication device 20A and access point 40 only upon determining that sensor 30A correctly captured the validation data, wherein sensor 30A and the validation data are such that sensor 30A correctly captures the validation data only whenever wireless communication device 20A is physically located within enclosed volume 1. Enclosed volume 10 may further include avionics 60 which may also be wirelessly connected to access point 40 over the wireless communication channel 70 on a secured connection or via a wired connection. A wireless communication device 20B located outside of enclosed volume 10 carried by person 1B would not be admitted to wireless communication channel 70 by access point 40 since sensor 30B of wireless communication device 20B cannot capture the validation data generated by validation device 50.

According to some embodiments of the present invention, sensor 30A may include a camera and wherein the validation data may include visual data such as an automatically generated quick response (QR) code and validation device 50 may be an electronic display presenting the QR code, possibly as part of avionics 60.

According to some embodiments of the present invention, sensor 30A may include a near field communication (NFC) unit, wherein validation device 50 may include an NFC unit as well, and wherein the validation data may include data communicated between the NFC unit of wireless communication device 20A and the NFC unit of validation device 50.

According to some embodiments of the present invention, enclosed volume 1 may include a cockpit of an aircraft.

According to some embodiments of the present invention, validation device 50 may be embedded within avionics equipment 60, for example as part of an electronic display thereof.

According to some embodiments of the present invention, the validation data may be updated upon every establishing of the wireless communication channel 70 and maintained for a predefined session, for example for the entire flight.

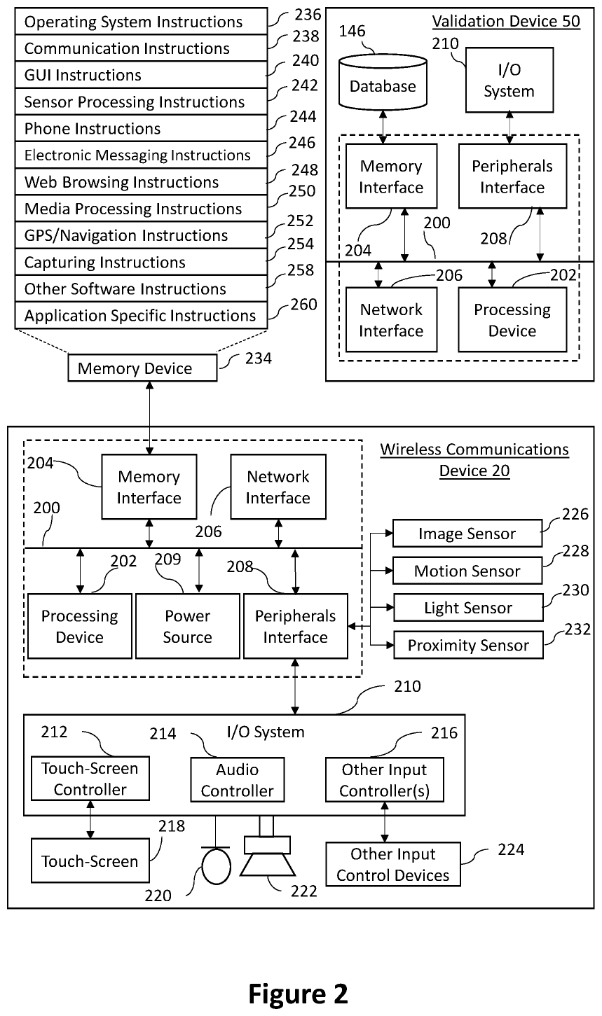

FIG. 2 is a block diagram illustrating possible configurations of validation device 50 and wireless communications device 20. In one embodiment, validation device 50 and wireless communications device 20 directly or indirectly accesses a bus 200 (or other communication mechanism) that interconnects subsystems and components for transferring information within validation device 50 and/or wireless communications device 20. For example, bus 200 may interconnect a processing device 202, a memory interface 204, a network interface 206, a peripherals interface 208 connected to I/O system 210, and power source 209.

Processing device 202 may include at least one processor configured to execute computer programs, applications, methods, processes, or other software to perform embodiments described in the present disclosure. For example, the processing device may include one or more integrated circuits, microchips, microcontrollers, microprocessors, all or part of a central processing unit (CPU), graphics processing unit (GPU), digital signal processor (DSP), field programmable gate array (FPGA), or other circuits suitable for executing instructions or performing logic operations. The processing device may include at least one processor configured to perform functions of the disclosed methods such as a microprocessor. The processing device may include a single core or multiple core processors executing parallel processes simultaneously. In one example, the processing device may be a single core processor configured with virtual processing technologies. The processing device may implement virtual machine technologies or other technologies to provide the ability to execute, control, run, manipulate, store, etc., multiple software processes, applications, programs, etc. In another example, the processing device may include a multiple-core processor arrangement (e.g., dual, quad core, etc.) configured to provide parallel processing functionalities to allow a device associated with the processing device to execute multiple processes simultaneously. It is appreciated that other types of processor arrangements could be implemented to provide the capabilities disclosed herein.

In some embodiments, processing device 202 may use memory interface 204 to access data and a software product stored on a memory device or a non-transitory computer-readable medium. For example, validation device 50 may use memory interface 204 to access data structure 146. As used herein, a non-transitory computer-readable storage medium refers to any type of physical memory on which information or data readable by at least one processor can be stored. The terms “memory” and “computer-readable storage medium” may refer to multiple structures, such as a plurality of memories or computer-readable storage mediums located within wireless communications device 20, validation device 50, or at a remote location.

Additionally, one or more computer-readable storage mediums can be utilized in implementing a computer-implemented method. The term “computer-readable storage medium” should be understood to include tangible items and exclude carrier waves and transient signals.

Both wireless communications device 20 and validation device 50 may include network interface 206 coupled to bus 200. Network interface 206 may provide two-way data communications to a network, such as network 150. The wireless communication between wireless communications device 20 and validation device 50 is represented by a dashed arrow. In one embodiment, network interface 206 may include an integrated services digital network (ISDN) card, cellular modem, satellite modem, or a modem to provide a data communication connection over the Internet. As another example, network interface 206 may include a wireless local area network (WLAN) card. In another embodiment, network interface 206 may include an Ethernet port connected to radio frequency receivers and transmitters and/or optical (e.g., infrared) receivers and transmitters. The specific design and implementation of network interface 206 may depend on the communications network(s) over which wireless communications device 20 and validation device 50 are intended to operate. For example, in some embodiments, wireless communication device 20 may include network interface 206 designed to operate over a GSM network, a GPRS network, an EDGE network, a Wi-Fi or LTE network, 5G network and a Bluetooth® network. In any such implementation, network interface 206 may be configured to send and receive electrical, electromagnetic or optical signals that carry digital data streams representing various types of information

Both wireless communications device 20 and validation device 50 may also include peripherals interface 208 coupled to bus 200. Peripherals interface 208 may be connected to sensors, devices, and subsystems to facilitate multiple functionalities. In one embodiment, peripherals interface 208 may be connected to I/O system 210 configured to receive signals or input from devices and to provide signals or output to one or more devices that allow data to be received and/or transmitted by wireless communication device 20 and validation device 50. In one example, I/O system 210 may include a touch screen controller 212, audio controller 214, and/or other input controller(s) 216. Touch screen controller 212 may be coupled to a touch screen 218. Touch screen 218 and touch screen controller 212 may, for example, detect contact, movement or break thereof using any of a plurality of touch sensitivity technologies, including but not limited to capacitive, resistive, infrared, and surface acoustic wave technologies as well as other proximity sensor arrays or other elements for determining one or more points of contact with the touch screen 218. Touch screen 218 may also, for example, be used to implement virtual or soft buttons and/or a keyboard. While a touch screen 218, I/O system 210 may include a display screen (e.g., LCD or OLED) in place of touch screen 218. Audio controller 214 may be coupled to a microphone 220 and a speaker 222 to facilitate voice-enabled functions, such as voice recognition, voice replication, digital recording, and telephony functions. The other input controller(s) 216 may be coupled to other input/control devices 224, such as one or more buttons, rocker switches, thumbwheel, infrared port, USB port, and/or a pointer device such as a stylus.

In another embodiment, I/O system 210 may include near field communication (NFC) units, the validation data is data communicated between the NFC unit of the wireless communication device 20A and the NFC unit of the validation device 50.

With regard to wireless communication device 20, peripherals interface 208 may also be connected to an image sensor 226, a motion sensor 228, a light sensor 230, and/or a proximity sensor 232 to facilitate image capturing, orientation, lighting, and proximity functions. Other sensors (not shown) may also be connected to the peripherals interface 208, such as a temperature sensor, a biometric sensor, or other sensing devices to facilitate related functionalities. In addition, a GPS receiver may also be integrated with, or connected to, wireless communication device 20, such as GPS receivers typically integrated into mobile communications devices. Alternatively, GPS software may permit a mobile communications device to access AN external GPS receiver (e.g., connecting via a serial port or Bluetooth).

Consistent with the present disclosure, wireless communication device 20 may use memory interface 204 to access memory device 234. Memory device 234 may include high-speed random-access memory and/or non-volatile memory such as one or more magnetic disk storage devices, one or more optical storage devices, and/or flash memory (e.g., NAND, NOR). Memory device 234 may store an operating system 236, such as DARWIN, RTXC, LINUX, iOS, UNIX, OSX, WINDOWS, or an embedded operating system such as VxWorks. The operating system 236 may include instructions for handling basic system services and for performing hardware-dependent tasks. In some implementations, the operating system 236 may be a kernel (e.g., UNIX kernel).

Memory device 234 may also store communication instructions 238 to facilitate communicating with one or more additional devices, one or more computers and/or one or more validation devices. Memory device 234 may include: graphical user interface instructions 240 to facilitate graphic user interface processing; sensor processing instructions 242 to facilitate sensor-related processing and functions; phone instructions 244 to facilitate phone-related processes and functions; electronic messaging instructions 246 to facilitate electronic-messaging related processes and functions; web browsing instructions 248 to facilitate web browsing-related processes and functions; media processing instructions 250 to facilitate media processing-related processes and functions; GPS/navigation instructions 252 to facilitate GPS and navigation-related processes and instructions; capturing instructions 254 to facilitate processes and functions related to image sensor 226; and/or other software instructions 258 to facilitate other processes and functions. Memory device 234 may also include application specific instructions 260 to facilitate a process for guiding person 1A on the steps of directing sensor 30A to capture validation data from a validation device 50 physically located within enclosed volume 10.

Each of the above identified instructions and applications may correspond to a set of instructions for performing one or more functions described above. These instructions need not be implemented as separate software programs, procedures, or modules. Memory device 234 may include additional instructions or fewer instructions. Furthermore, various functions of wireless communication device 20 may be implemented in hardware and/or in software, including in one or more signal processing and/or application specific integrated circuits. For example, wireless communication device 20 may execute an image processing algorithm to identify objects in a received image. In addition, the components and arrangements described herein are not intended to limit the disclosed embodiments. As will be appreciated by a person skilled in the art having the benefit of this disclosure, numerous variations and/or modifications may be made to the depicted configuration of validation device 50. For example, not all components may be essential for the operation of validation device 50 in all cases. Any component may be located in any appropriate part of validation device 50, and the components may be rearranged into a variety of configurations while providing the functionality of the disclosed embodiments. For example, some validation devices may not include all the elements in I/O system 210.

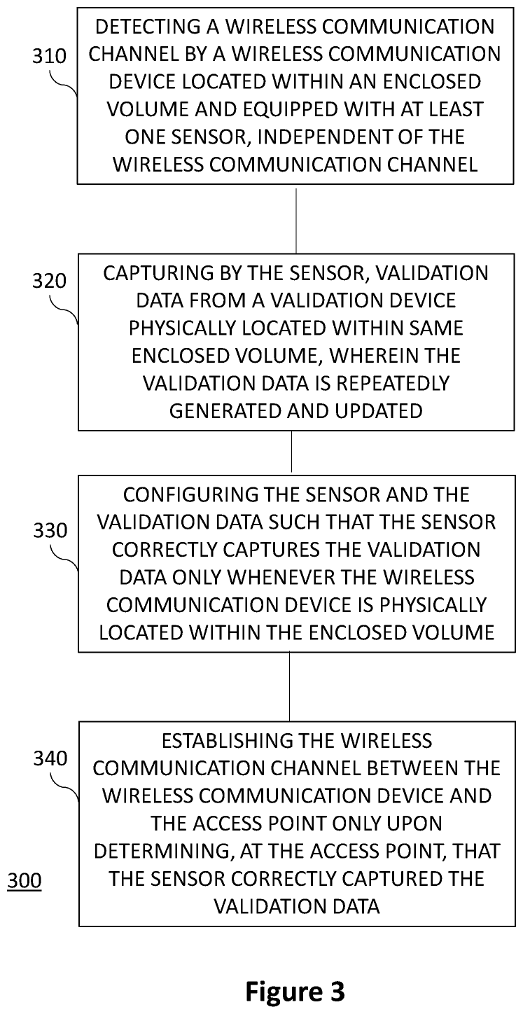

FIG. 3 is a high-level flowchart illustrating non-limiting exemplary method in accordance with embodiments of the present invention. Method 300 for validating a physical presence of a wireless communication device within an enclosed volume, upon establishing a wireless communication channel with an access point physically located within the enclosed volume, the method may include the following steps: detecting the wireless communication channel by a wireless communication device equipped with at least one sensor, independent of the wireless communication channel 310; capturing by the sensor, validation data from a validation device physically located within the enclosed volume, wherein the validation data is repeatedly generated and updated 320; configuring the sensor and the validation data such that the sensor correctly captures the validation data only whenever the wireless communication device is physically located within the enclosed volume 330; and establishing the wireless communication channel between the wireless communication device and the access point only upon determining, at the access point, that the sensor correctly captured the validation data 340.

According to some embodiments of the present invention, the sensor of method 300 may include camera and wherein the validation data may include visual data and the validation device is an electronic display.

According to some embodiments of the present invention, the sensor of method 300 may include the sensor is a near field communication (NFC) unit, wherein the validation device comprises an NFC unit, and wherein the validation data is data communicated between the NFC unit of the wireless communication device and the NFC unit of the validation device

According to some embodiments of the present invention, the enclosed volume of method 300 may include a cockpit of an aircraft.

According to some embodiments of the present invention, the validation device of method 300 may be embedded within avionics equipment.

According to some embodiments of the present invention, the validation data of method 300 may be updated upon each establishment of said wireless communication channel and maintained for a predefined session.

It should be noted that method 300 according to embodiments of the present invention may be stored as instructions in a computer readable medium to cause processors, such as central processing units (CPU) to perform the method. Additionally, the method described in the present disclosure can be stored as instructions in a non-transitory computer readable medium, such as storage devices which may include hard disk drives, solid state drives, flash memories, and the like. Additionally, non-transitory computer readable medium can be memory units.

In order to implement the method according to embodiments of the present invention, a computer processor may receive instructions and data from a read-only memory or a random-access memory or both. At least one of aforementioned steps is performed by at least one processor associated with a computer. The essential elements of a computer are a processor for executing instructions and one or more memories for storing instructions and data. Generally, a computer will also include, or be operatively coupled to communicate with, one or more mass storage devices for storing data files. Storage modules suitable for tangibly embodying computer program instructions and data include all forms of non-volatile memory, including by way of example semiconductor memory devices, such as EPROM, EEPROM, and flash memory devices and also magneto-optic storage devices.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit”, “module” or “system”. Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object-oriented programming language such as Java, Smalltalk, JavaScript Object Notation (JSON), C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or portion diagrams of methods, apparatus (systems) and computer program products according to embodiments of the invention. It will be understood that each portion of the flowchart illustrations and/or portion diagrams, and combinations of portions in the flowchart illustrations and/or portion diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or portion diagram portion or portions.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or portion diagram portion or portions.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or portion diagram portion or portions.

The aforementioned flowchart and diagrams illustrate the architecture, functionality, and operation of possible implementations of systems, methods and computer program products according to various embodiments of the present invention. In this regard, each portion in the flowchart or portion diagrams may represent a module, segment, or portion of code, which comprises one or more executable instructions for implementing the specified logical function(s). It should also be noted that, in some alternative implementations, the functions noted in the portion may occur out of the order noted in the figures. For example, two portions shown in succession may, in fact, be executed substantially concurrently, or the portions may sometimes be executed in the reverse order, depending upon the functionality involved. It will also be noted that each portion of the portion diagrams and/or flowchart illustration, and combinations of portions in the portion diagrams and/or flowchart illustration, can be implemented by special purpose hardware-based systems that perform the specified functions or acts, or combinations of special purpose hardware and computer instructions.

In the above description, an embodiment is an example or implementation of the inventions. The various appearances of “one embodiment”, “an embodiment”, or “some embodiments” do not necessarily all refer to the same embodiments.

Although various features of the invention may be described in the context of a single embodiment, the features may also be provided separately or in any suitable combination.

Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures, and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting of” and grammatical variants thereof do not preclude the addition of one or more components, features, steps, or integers or groups thereof and that the terms are to be construed as specifying components, features, steps, or integers.

If the specification or claims refer to “an additional” element, that does not preclude there being more than one of the additional elements.

It is to be understood that where the claims or specification refer to “a” or “an” element, such reference is not construed that there is only one of that elements.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation, or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

1. A method of validating a physical presence of a wireless communication device within an enclosed volume, upon establishing a wireless communication channel with an access point physically located within said enclosed volume, the method comprising:
detecting said wireless communication channel by the wireless communication device equipped with at least one sensor capable of sensing signals independent of said wireless communication channel;
capturing by the sensor, validation data from a validation device physically located within said enclosed volume, wherein said validation data is repeatedly generated and updated; and
establishing said wireless communication channel between said wireless communication device and said access point only upon determining, at the access point, that the sensor correctly captured said validation data,
wherein the sensor and the validation data are such that the sensor correctly captures the validation data only whenever said wireless communication device is physically located within said enclosed volume.

2. The method according to claim 1, wherein the sensor comprises a camera and wherein the validation data comprises visual data and the validation device comprises an electronic display.

3. The method according to claim 1, wherein the sensor comprises a near field communication (NFC) unit, wherein the validation device comprises an NFC unit, and wherein the validation data comprises data communicated between the NFC unit of the wireless communication device and the NFC unit of the validation device

4. The method according to claim 1, wherein the enclosed volume comprises a cockpit of an aircraft.

5. The method according to claim 1, wherein the validation device is embedded within avionics equipment.

6. The method according to claim 1, wherein the validation data is updated upon each establishment of said wireless communication channel and maintained for a predefined session.

7. A system for validating a physical presence of a wireless communication device within an enclosed volume, upon establishing a wireless communication channel with an access point physically located within said enclosed volume, the system comprising:
a validation device physically located within said enclosed volume and configured to generate validation data, wherein said validation data is repeatedly generated and updated;
a wireless communication device equipped with at least one sensor capable of sensing signals independent of said wireless communication channel, wherein the sensor is configured to capture the validation data from said validation device; and
an access point physically located within the enclosed volume and configured to establish said wireless communication channel between said wireless communication device and said access point only upon determining that the sensor correctly captured said validation data,
wherein the sensor and the validation data are configured such that the sensor correctly captures the validation data only whenever said wireless communication device is physically located within said enclosed volume.

8. The system according to claim 7, wherein the sensor comprises a camera and wherein the validation data comprises visual data and the validation device is an electronic display.

9. The system according to claim 7, wherein the sensor comprises a near field communication (NFC) unit, wherein the validation device comprises an NFC unit, and wherein the validation data is data communicated between the NFC unit of the wireless communication device and the NFC unit of the validation device

10. The system according to claim 7, wherein the enclosed volume comprises a cockpit of an aircraft.

11. The system according to claim 7, wherein the validation device is embedded within avionics equipment.

12. The system according to claim 7, wherein the validation data is updated upon each establishment of said wireless communication channel and maintained for a predefined session.

13. A non-transitory computer readable medium for validating a physical presence of a wireless communication device within an enclosed volume, upon establishing a wireless communication channel with an access point physically located within said enclosed volume, the computer readable medium comprising a set of instructions that when executed cause at least one computer processor to:
instruct a wireless communication device equipped with at least one sensor capable of sensing signals independent of the wireless communication channel, to detect said wireless communication channel and instruct the sensor to capture validation data from a validation device physically located within said enclosed volume, wherein said validation data is repeatedly generated and updated; and
instruct an access point physically located within the enclosed volume to establish said wireless communication channel between said wireless communication device and said access point only upon determining that the sensor correctly captured said validation data,
wherein the sensor and the validation data are configured such that the sensor correctly captures the validation data only whenever said wireless communication device is physically located within said enclosed volume.

14. The non-transitory computer readable medium according to claim 13, wherein the sensor comprises a camera and wherein the validation data comprises visual data and the validation device is an electronic display.

15. The non-transitory computer readable medium according to claim 13, wherein the sensor comprises a near field communication (NFC) unit, wherein the validation device comprises an NFC unit, and wherein the validation data is data communicated between the NFC unit of the wireless communication device and the NFC unit of the validation device

16. The non-transitory computer readable medium according to claim 13, wherein the enclosed volume comprises a cockpit of an aircraft.

17. The non-transitory computer readable medium according to claim 13, wherein the validation device is embedded within avionics equipment.

18. The non-transitory computer readable medium according to claim 13, wherein the validation data is updated upon each establishment of said wireless communication channel and maintained for a predefined session.
